(19) United States
(12) Patent Application Publication
(10) Pub. No.: US 2019/0057441 A1
(43) Pub. Date: Feb. 21, 2019

(54) METHOD AND SYSTEM FOR ALLOCATING A PRICE DISCOVERY MECHANISM IN A DATA MARKETPLACE

(71) Applicant: Tata Consultancy Services Limited, Mumbai (IN)

(72) Inventors: Shishir DAHAKE, Pune (IN); Kishore PADMANABHAN, Chennai (IN); Vijayarangan NATARAJAN, Chennai (IN); Sandeep SAXENA, Gurgaon (IN); Ram Harith VISWANATHAN, Chennai (IN)

(73) Assignee: Tata Consultancy Services Limited, Mumbai (IN)

(21) Appl. No.: 16/078,820

(22) PCT Filed: Feb. 22, 2017
(86) PCT No.: PCT/IB2017/051003

§ 371 Date: Aug. 22, 2018

(30) Foreign Application Priority Data
Feb. 22, 2016 (IN) 201621006137

(51) Int. Cl. G06Q 30/08; G06Q 30/02; G06Q 40/04

(52) U.S. Cl. CPC G06Q 30/08; G06Q 40/04; G06Q 30/0206

(57) ABSTRACT

A method and system is provided for allocating a suitable price discovery mechanism in a data marketplace. The system takes a set of requirements from one or more buyers and a set of specifications for the data products from one or more sellers. The matching is performed on the set of requirements and the set of specifications of the data products to determine whether data transaction should be proceeded or not. The output is then provided to the classification module to classify the data marketplace to choose the most suitable price discovery mechanism which can be used for a particular data transaction in the data marketplace. The system can use of any of the following price discovery techniques. Bid order matching, auctioning or direct negotiation. Once the price is finalized, the finalized price then can be send to an order management module of the data marketplace.

### CROSS-REFERENCE TO RELATED APPLICATIONS AND PRIORITY

The present application claims priority from Indian Provisional Patent Application No. 201621006137, filed on Feb. 22, 2016, the entirety of which is hereby incorporated by reference.

### TECHNICAL FIELD

The present application generally relates to the field of price discovery. More particularly, but not specifically, the invention is related to method and system for allocating a price discovery mechanism in a data marketplace.

### BACKGROUND

Nowadays, a huge amount of data is generated by multiple sources and can be put to multiple uses. To facilitate easy interchange and monetization of data, the concept of a data marketplace is getting very popular day by day. A data marketplace is an online platform where users may buy, sell, trade, and/or otherwise transact data with other users for agreed upon compensation and other predefined terms and condition.

Price discovery is a process that involves buyers and sellers arriving at a transaction price for a specific item at a given time. It involves the details of buyers and sellers (number, size, location, and valuation perceptions), market mechanism (bidding and settlement process, liquidity), available information (amount, timeliness, significance and reliability) and risk management tools in order to regulate and efficiently run any market and ensure all sides in a transaction fulfill their obligations. In the data marketplace where a high volume of business transactions for buying and selling of data would take place, it is very important to have an efficient price discovery mechanism.

Data or data sets or data product are different to standardized commodities traded in various markets around the world such as the London Metal Exchange in the United Kingdom. Some points of difference are as: First, data or data sets are mostly non-standardized as opposed to standardized commodities being traded on world markets. For example, the frozen concentrated orange juice traded on the intercontinental exchange has specific conditions of quality, quantity and settlement. Data or data sets don't however adhere to such specific standards of quality. Different data sets might have slight differences such as number of columns, precision of individual data points. Secondly, the same data set may be sold to multiple different parties. A single sale might have multiple buyers. The same is not true in the case of physical commodities.

One of the major problems in the data marketplace is the fact that very similar datasets have small differences. For example, one dataset having car GPS locations taken every 1 s with 7 Decimal Digits precision and another having car GPS locations taken every 3 s with 5 Decimal Digits. These data sets could now be classified as either similar offerings on sale or different one's based on an individual buyer's preferences. Hence classification of datasets as similar or dis-similar is the first critical decision to understand the number of effective buyers and sellers which are available for completing a given transaction.

Another drawback in establishing an effective data marketplace is the nature of the market for a product on sale is heavily dependent on the fact that the market could consist of the various different situations. In different situations, misinterpreting market conditions and matching them to the wrong method of price discovery could lead to market in-efficiencies. This situation leads to inefficient price discovery as individual negotiations would take place for each and every sale.

In addition to that, if auctions are chosen as the method of price discovery, various auction mechanisms, such as English auctions, Dutch auctions, Vickery auctions (or second price sealed bid auctions) are available. Each of these auctions fulfills a different economic goal and the buyers and sellers are best suited to choose the kind of auction mechanism to be used in order to fulfill their own economic goals. However, in order to run an efficient market, buyers or sellers who hold a position of strength in the market would need to be identified and be allowed to set the terms of the auction.

As there are multiple sales of the same item possible it becomes necessary to have a single price for a data product (the same data may be sold at different prices by configuring different products). Various other efforts have been made to provide a solution for above mentioned problems, but none of them have been convincing.

### SUMMARY

The following presents a simplified summary of some embodiments of the disclosure in order to provide a basic understanding of the embodiments. This summary is not an extensive overview of the embodiments. It is not intended to identify key/critical elements of the embodiments or to delineate the scope of the embodiments. Its sole purpose is to present some embodiments in a simplified form as a prelude to the more detailed description that is presented below.

In view of the foregoing, an embodiment herein provides a system for allocating a price discovery mechanism in a data marketplace. The system comprises a user interface, a memory and a processor in communication with the memory. The user interface accesses the data marketplace by a one or more sellers and a one or more buyers. The one or more buyers provide a set of requirements for data products and the one or more sellers provide a set of specifications of data products for sale. The processor further configured to perform the steps of: matching the set of requirements of the buyers with the set of specifications using a matching module, wherein the output of the matching module is used to decide whether to proceed with data transactions or not; classifying the data marketplace based on a number of buyers and a number of sellers accessing the data marketplace using a classification module; and allocating a price discovery mechanism to at least one of a bid order matching mechanism, an auctioning mechanism or a direct negotiation mechanism for the data marketplace based on the classification.

Another embodiment provides a processor implemented method for allocating a price discovery mechanism in a data marketplace. Initially, the data marketplace is accessed by a one or more buyers with a set of requirements for data products. Simultaneously, the data marketplace is also accessed by a one or more sellers with the data products for sale, wherein the data products have a set of specifications. In the next step, the set of requirements of the buyers are matched with the set of specifications of the data products using a matching module. The output of the matching module is used to decide whether to proceed with data transactions or not. In the next step, the data marketplace is classified based on a number of buyers and a number of sellers accessing the data marketplace using a classification module. And finally a price discovery mechanism is allocated to at least one of a bid order matching mechanism, an auctioning mechanism or a direct negotiation mechanism for the data marketplace based on the classification.

### BRIEF DESCRIPTION OF THE DRAWINGS

The embodiments herein will be better understood from the following detailed description with reference to the drawings, in which:

FIG. 1 shows a block diagram of a system for allocating a price discovery mechanism in a data marketplace in accordance with an embodiment of the disclosure;

FIG. 2 shows a graphical representation of number of buyers with the number of sellers in the data marketplace in accordance with another embodiment of the disclosure;

FIG. 3 shows a graphical representation of buyers by sellers ratio against the number of buyers and sellers in the data marketplace in accordance with another embodiment of the disclosure; and

FIG. 4 shows a flow chart illustrating the steps involved in allocating a price discovery mechanism in a data marketplace in accordance with an embodiment of the disclosure.

### DETAILED DESCRIPTION

The embodiments herein and the various features and advantageous details thereof are explained more fully with reference to the non-limiting embodiments that are illustrated in the accompanying drawings and detailed in the following description. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

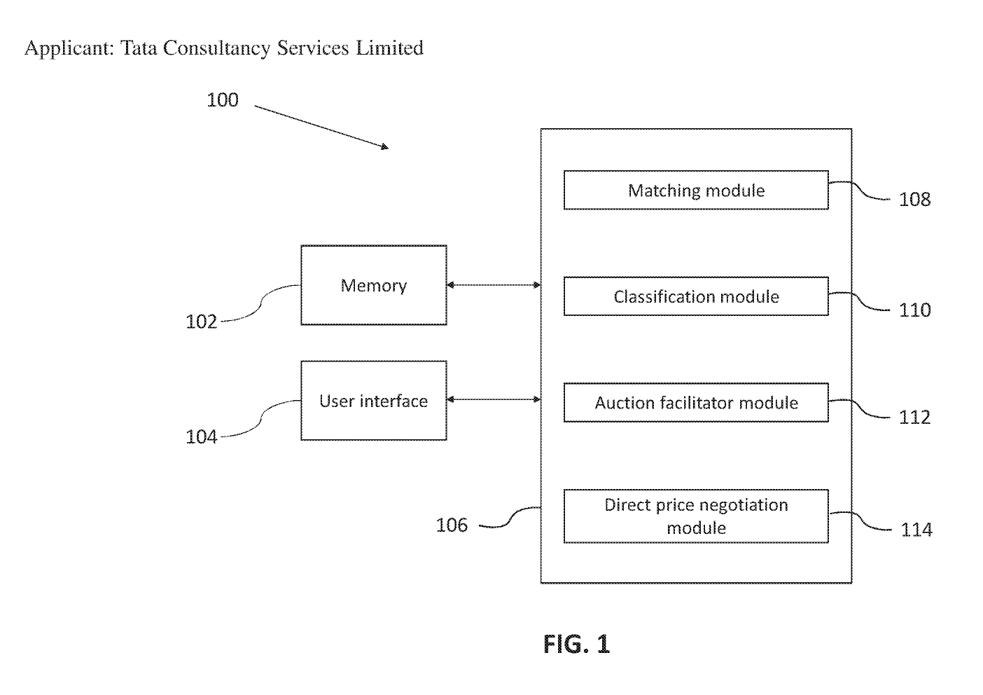

Referring now to the drawings, and more particularly to FIG. 1 to FIG. 4, where similar reference characters denote corresponding features consistently throughout the figures, there are shown preferred embodiments and these embodiments are described in the context of the following exemplary system and/or method.

The expression “data products” or “data” in the context of the present disclosure refers to data pertaining to business intelligence, advertising, demographics, personal information, research and market data, and the like, that may be traded in the form of an asset on data marketplace. In accordance with the present disclosure, the data products may be characterized by one or more attributes, some of which may be mutable attributes and some immutable attributes.

The expression “one or more buyers” in the context of the present disclosure refers to a person or an organization or a party which is willing to buy a data product from the data marketplace. Accordingly “one or more sellers” in the context of the present disclosure refers to a person or an organization or a party which is willing to sell a data product from the data marketplace.

FIG. 1 illustrates a schematic block diagram of a system 100 for allocating a price discovery mechanism in a data marketplace according to an embodiment of the disclosure. The system 100 configured to match the required data specifications of the one or more buyers with the available data specifications of one or more sellers to allocate most suitable price discovery mechanism. The allocated price discovery mechanism is then used to decide the price and terms and condition in the data transaction.

The system 100 comprises a user interface 102, a memory 104 and a processor 106. The processor 106 further includes a matching module 108, a classification module 110, an auction facilitator module 112 and a direct price negotiation module 114. The user interface 102 is configured to input a set of specifications corresponding to the data products provided by the one or more buyers or the one or more sellers in the system 100. In case of the one or more buyers, then the set of data specifications include a set of requirements. The set of requirements are for the data products which the one or more buyers wants to buy. The one or more buyers also asked to submit clear requirement of the precision levels required. In case the one or more sellers, then the set of specifications include available set of specification of the data products. The set of specifications includes all the information about the data products which is made available for sale in the data marketplace.

According to an embodiment of the disclosure, the matching module 108 is configured to match the set of requirements of the one or more buyers with the set of specifications of the data products provided by the one or more sellers. The output of the matching module 108 determines whether system needs to proceed with the data transaction or not. In case, there is no match between the set of requirements and the set of specifications then the data transaction may be stopped. If the set of requirements matches with the set of specifications, then the output of the matching module 108 is given to the classification module 110.

In an example, the classification module 110 may also be referred as a market classifier 110. The classification module 110 is configured to classify the market based on the number of buyers and sellers accessing in the data marketplace. It should be appreciated that the classification is performed only for the total number of buyers and the total number of sellers who are willing transact a similar data product in the data marketplace. The classification is performed to choose the best possible price discovery mechanism using a classification algorithm. In an embodiment of the disclosure, the price discovery mechanism can be chosen from at least one of a bid-order matching mechanism, auctioning mechanism and a direct negotiations mechanism. It should be appreciated that the choice of any other kind of price discovery mechanism is well within the scope of this disclosure.

The matching of the matching module 108 can be performed by one of the various existing matching algorithms including use of industry-domain ontologies and Natural Language Processing and the like. In an example, the matching can be performed by matching the set of specifications of the data products provided by the one or more sellers with the set of requirements of the one or more buyers. In certain formats, the data product is provided in the form of column with their column id. In such case, the column id and/or data within columns are matched using the matching module 108. For Example, a buyer specification requires location data in terms of Latitude and Longitude and the same is available with a seller. Furthermore, columns in a data product could be syntactically matched to a data specification, even though column descriptions don't match directly.

In another example, the matching can be done on the basis of precision level of data elements present in the data products. For example, different number of digits after the decimal point in Longitude and Latitude readings provides a different class of information as shown in an example below.

| Precision Levels of | | Data Precision |
|---|---|---|
| GPS Co-Ordinates | Example Co-ordinates | Available |
| Ten's Digit | 1*N, 7*E (units digits | +/−1000 km |
| | being unknown/unwanted) | Identification of |
| | | major geographical |
| | | locator such as |
| | | continent or ocean |
| Unit's Digit | 18N, 73E | +/−111 km |
| | | Identification of |
| | | State or Country |
| First Decimal | 18.5N, 73.9E | +/−11.1 km |
| Place | | Helps in identifi- |
| | | cation of a city |
| Second Decimal | 18.51N, 73.91E | +/−1.1 km |
| Place | | Helps in identifi- |
| | | cation of a locality |
| Third Decimal | 18.511N, 73.916E | +/−110 m |
| Place | | Identification of |
| | | a large football |
| | | field |
| Fourth Decimal | 18.5119N, 73.9167E | +/−11 m |
| Place | | Identification of |
| | | a house |
| Fifth Decimal | 18.51192N, 73.91671E | +/−1.1 m |
| Place | | Identification of |
| | | a stop sign |

Hence, for purposes of identification of cities, precision level longitude and latitude information of up to second decimal digit is sufficient and data products with more decimal digits would also work fine. However, if identification of specific features on a road such as a pothole is required, only data products having up to five decimal places of accuracy would help. So based on the precision level requirement of the buyer, the matching can be performed using the matching module 108.

According to another embodiment of the disclosure, the data products can also be matched using statistical considerations such as means, standard deviation and type of (frequency) distributions in column values and correlations between columns. Examples of this could be average for account balance fields in banking datasets, correlations between age and disease columns in a medical dataset. Similarly, profit and loss data in a stock market index could have a very specific distribution.

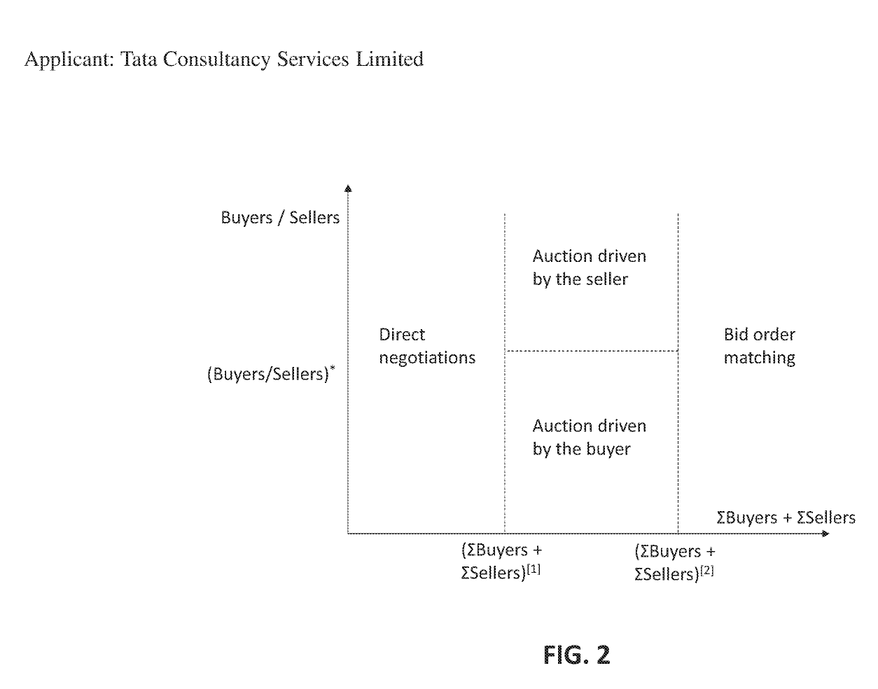

According to an embodiment of the disclosure, the system 100 can determine the price discovery mechanism to choose based on various scenario as shown in FIG. 2. The identification of type of market is seen to be a function of the following parameters:

(a) Number of total buyers and sellers available in the data marketplace for transacting a similar data product (Σ Buyers+Σ Sellers)
(b) Ratio of Buyers and Sellers in the data marketplace (Buyers/Sellers)*

In an embodiment of the disclosure, threshold levels may be chosen to allocate the price discovery mechanism. A first threshold (Σ Buyers+Σ Sellers)⁽¹⁾ and the second threshold level is decided (Σ Buyers+Σ Sellers)⁽²⁾ for the total number of buyers and sellers transacting the similar data product in the data marketplace. A third threshold level is decided for the ratio of the total number of buyers and the total number of sellers the similar data product in the data marketplace These thresholds could be decided by using various kinds of classification algorithms such as logistic regression.

There could be four scenarios based on the number of buyers and sellers transacting the similar data product in the data marketplace. First, there are limited number of buyers and sellers in the data marketplace, the best suited price discovery mechanism is direct negotiations between the buyers and the sellers. The direct negotiations can be performed using the direct price discover module 114. Second, there are extremely large numbers of buyers and sellers in the data marketplace, the best suited price discovery mechanism is open market mechanism with bid order matching characteristics. Third, there are large number of buyers but limited number of sellers in the marketplace, the best suited price discovery mechanism is auctioning of data products from the seller's perspective. And fourth, there are large number of sellers but limited number of buyers in the data marketplace, the best suited price discovery mechanism is auctioning of data products from the buyer's perspective.

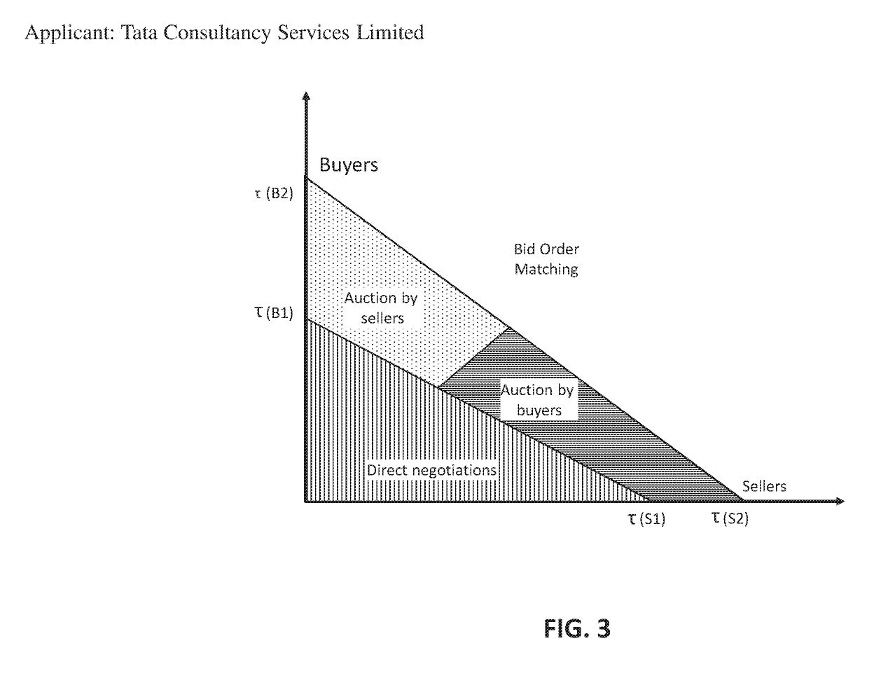

According to another embodiment of the disclosure, an alternate classification may occur as shown in the FIG. 3, according to an embodiment of the inventions. Here the x-axis is represented by the number of sellers in the data marketplace and the y-axis is represented by the number of buyers in the data marketplace transacting the similar data product. The critical values are represented by τ (B1) as first buyer threshold, τ (B2) as second buyer threshold, τ (S1) as first seller threshold and τ (S2) as second seller threshold. It should be appreciated that other methods of demarcation may also exist. For example, behavioral theory could be used, wherein specific buyers (or sellers) are identified as operating only buyers (or sellers) markets. In such cases, participation of a particular buyer in a type of a market could be a strong indication of being in a buyers (or sellers) market.

According to an embodiment of the disclosure, the trade can be closed using auctioning method. The auction is performed when there are more numbers of buyers and sellers. One of the methods of identifying auction leaders could be using the Ballot Problem framed by Joseph Bertrand in 1887 and a proof of this was offered by Desire Andre. The Ballot Problem was framed as:

“Suppose that two candidates, A and B, are in an election where candidate A receives a votes, candidate B receives b votes, and a>b. How many ways can the (a+b) ballots be ordered so that while the ballots are being counted, candidate A maintains a constant lead over B?” Joseph Bertrand provided an inductive proof that the answer to this problem is

$$\frac{a - b}{a + b} ( \begin{matrix}a + b \\ a\end{matrix} )$$

The problem could be rephrased to understand weather buyers or sellers should be given the right to conduct an auction. Various other auction mechanisms such as Dutch auctions, English auctions, Vickery auctions, first price, hybrid auction approaches and second price auctions exist. Each of these fulfills a different economic goal for the parties running the auction. The side controlling the auction shall hence set up terms for sale basis their individual economic goals to be fulfilled. Once the Auction terms are set up, these are published and individual buyers and sellers are provided with a window to withdraw from the auction. In case there are withdrawals, the platform begins the market classification loop again. In case the loop is still stable, price discovery takes place using auctioning mechanism.

In case the auction is proceeding beyond a limited number of cycles, say c=2, where c is the number of auction cycles, we can use the Martingale Stopping Theorem to ascertain the stopping point of an auction. Matt Van Essen of the University of Alabama presents an easy to understand tutorial on understanding Martingale's stopping theorem.

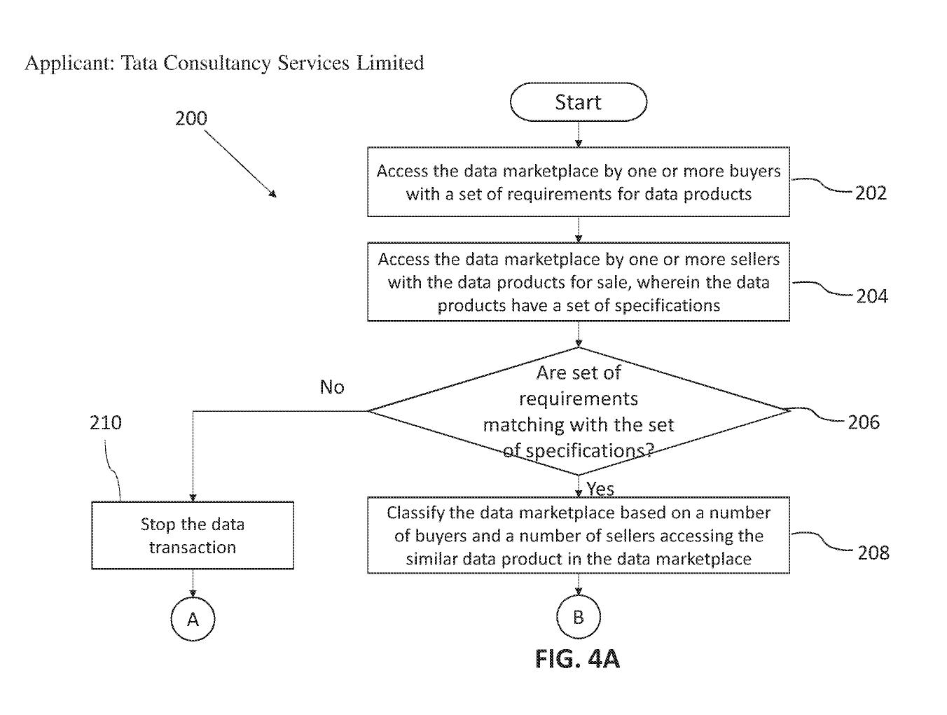

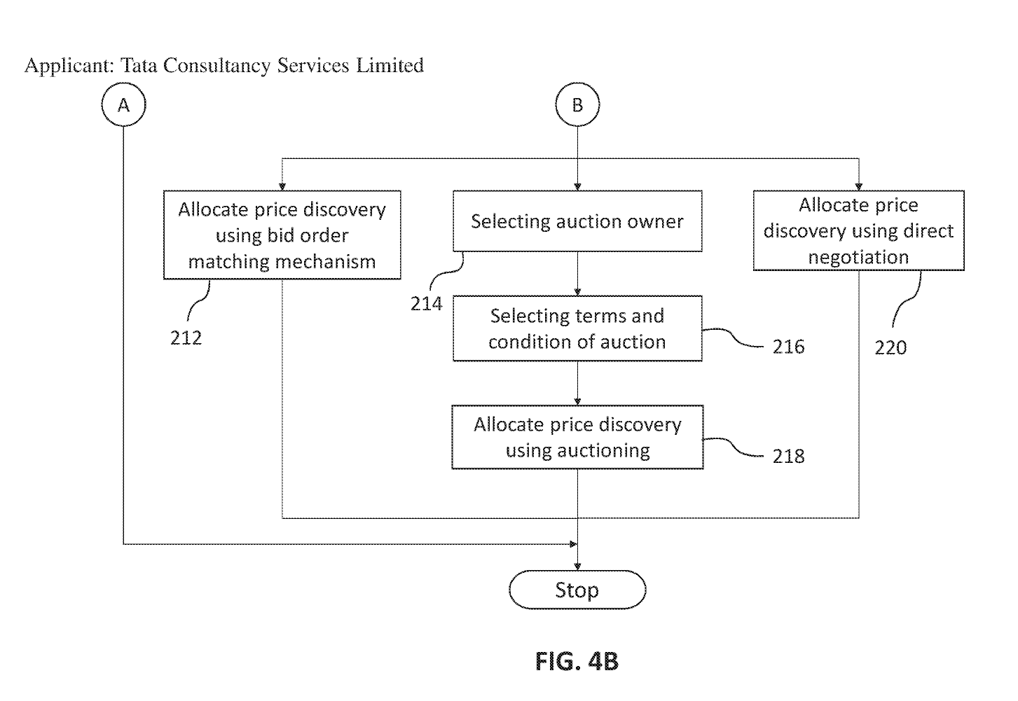

A flowchart 200 illustrating the steps involved for allocating the price discovery mechanism in the data marketplace is shown in FIG. 4, according to an embodiment of the invention. Initially at step 202, one or more buyers access in the data marketplace. The one or more buyers provide a set of requirements for data products. In the next step 204, one or more sellers access the data marketplace. The one or more sellers provide the set of specifications of the data products available for sale. At the next step 206, the set of requirements of the buyer are matched with the set of specifications of data products of the seller using the matching module 108. At the next step 208, based on the matching of the previous step, if the set of requirements matches with the set of specifications then the data marketplace is classified based on the number of buyers and the number of sellers accessing the similar data product in the data marketplace using the classification module 110. Otherwise at step 210, the data transaction is stopped.

In the next step, after classification, any one of the price discovery mechanism is allocated either step 212, 214 or 220. The allocation is done based on a predefined set of conditions as explained earlier using the classification module 110. At step 212, the price discovery is done using the bid-order matching mechanism. From step 214 to 218, the price discovery is done using auctioning mechanism. In the process of auctioning, initially at step 214 an owner for conducting an auction is selected. In the next step 216, the terms and condition are selected for the data transaction. And finally at step 218, price discovery is done using auctioning mechanism. At step 220, the price discovery is done using direct negotiations mechanism using a direct price negotiation module 114.

According to an embodiment of the disclosure, once the price is finalized using the method illustrated in the flowchart of FIG. 4, the finalized price is then given to an order management module (not shown in the Fig.) in the data marketplace. The order management module is configured to resolving conflicts prevalent in voluminous data hubs associated with buy orders and sell orders including metadata associated with product data, terms and conditions and price data. The conflict resolution is an automated and streamlined process that takes into account basic requirements of the one or more buyers and the one or more sellers along with a comprehensive resolution of conflicts that may arise during data transaction.

According to an embodiment of the disclosure, if the best form of price discovery mechanism is the auctioning, then the system 100 also provide a feature of determining right to own the auction either to the buyer or to the seller. It should be appreciated that this can be determined on the basis of the ability of the buyer to purchase a major portion of the available data products or the seller to control a major portion of the data products being made available in the data marketplace. It should also be appreciated that the auction can be performed using the auction facilitator module 112

According to an embodiment of the disclosure, the system 100 also provides a feature for handling combinatorial data products. It should be appreciated that more data can be generated by multiple operations. In an embodiment, more data can be generated by combining two data products together or information fusion. Consider in an example data product A is the voter roll for a constituency. The column elements for data product A consist of election roll number, name, date of birth, gender, and postal address. Similarly, data product B consists of redacted name data, but contains the actual date of birth, gender, postal code and income. In case someone combines data product A and data product B, one can reach to an understanding of a person's income by matching date of birth, gender and postal code found in the two data products.

In another example, consider a situation that data products A & B were available from two different sellers. Now, in case a buyer demands these two data products and only data product A and data product B together is required and that each one in isolation is not of use to the buyer. Also assume that no formal agreement for bundling data products between seller A and seller B exists with the marketplace. In such a case, we could use probability theory to understand the availability of data products A & B together for the purposes of estimation of market demand.

Let probability of a successful sale of data product A be P(A)=0.5

Similarly, probability of a successful sale of data product B be P(B)=0.5

Hence the combined probability of a successful sale of data product A & data product B be

P(A& B)=P(A)*P(B)=0.25

Hence for the purposes of demand estimation, combinatorial data products shall be counted as (0.5) n, where n is the number of data products which need to be combined together.

In case however, that buyer demands these two data products together, and a formal agreement for combining data products between sellers A & B exists with the market place, this shall be counted as a single source for the purposes of demand estimation.

According to another embodiment, the data products can also be generated by removing columns/schema elements from data products. It is possible that some data products available with sellers have more information than what has been specified by the buyers. This might be due to more than required table columns, or a higher than required precision of data elements. In such a situation, excess data shall be identified and redacted off. In such situations, the data product shall be counted as a single source for the purposes of demand estimation.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims. The embodiment, thus provides the system and method for allocating a price discovery mechanism in the data marketplace.

It is, however to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus to various devices such as a random access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example. The preceding description has been presented with reference to various embodiments. Persons having ordinary skill in the art and technology to which this application pertains will appreciate that alterations and changes in the described structures and methods of operation can be practiced without meaningfully departing from the principle, spirit and scope.

1. A method for allocating a price discovery mechanism in a data marketplace, the method comprising a processor (106) implemented steps of:
accessing the data marketplace by a one or more buyers with a set of requirements for data products;
accessing the data marketplace by a one or more sellers with the data products for sale, wherein the data products have a set of specifications;
matching the set of requirements of the buyers with the set of specifications using a matching module (108), wherein the output of the matching module is used to decide whether to proceed with data transactions or not;
classifying the data marketplace based on a number of buyers and a number of sellers accessing the data marketplace using a classification module (110); and
allocating a price discovery mechanism to at least one of a bid order matching mechanism, an auctioning mechanism or a direct negotiation mechanism for the data marketplace based on the classification.

2. The method of claim 1, wherein the step of allocating the price discovery mechanism further comprising:
determining a total number of buyers and sellers transacting a similar data product in the data marketplace;
determining a ratio of the total number of buyers and the total number of sellers transacting the similar data product in the data marketplace;
choosing a first threshold value and a second threshold value for the total number of buyers and sellers in the data marketplace, wherein the second threshold value is more than the first threshold value;
choosing a third threshold value for the ratio of the total number of buyers and the total number of sellers;
allocating direct negotiation mechanism as the price discovery mechanism if the total number of buyers and sellers are less than the first threshold value;
allocating bid order matching mechanism as the price discovery mechanism if the total number of buyers and the sellers are more than the second threshold value; and
allocating auctioning mechanism as the price discovery mechanism if the total number of buyers and sellers are between the first threshold value and the second threshold value.

3. The method of claim 2, wherein the auctioning mechanism is performed from the seller's perspective if the ratio of the total number of buyers and the total number of sellers is more than the third threshold value.

4. The method of claim 2, wherein the auctioning mechanism is performed from the buyer's perspective if the ratio of the total number of buyers and the total number of sellers is less than the third threshold value.

5. The method of claim 1, wherein the set of data products are characterized by one or more attributes being at least one of mutable attributes and immutable attributes.

6. The method of claim 1 further comprising selecting the terms and condition of the data transaction if price discovery is using the auctioning mechanism.

7. The method of claim 1 further comprising the step of selecting a buyer in case of more than one buyer is available with the same set of requirements.

8. The method of claim 1 further comprising the step of selecting a seller in case of more than one seller is available with the same data for a set of specifications for the set of data products.

9. A system for allocating a price discovery mechanism in a data marketplace, the system comprises:
a user interface (104) for accessing the data marketplace by a one or more sellers and a one or more buyers, wherein the one or more buyers provide a set of requirements for data products and the one or more sellers provide a set of specifications of data products for sale;
a memory (102); and
a processor (106) in communication with the memory, the processor further configured to perform the steps of:
matching the set of requirements of the buyers with the set of specifications using a matching module (108), wherein the output of the matching module is used to decide whether to proceed with data transactions or not;
classifying the data marketplace based on a number of buyers and a number of sellers accessing the data marketplace using a classification module (110); and
allocating a price discovery mechanism to at least one of a bid order matching mechanism, an auctioning mechanism or a direct negotiation mechanism for the data marketplace based on the classification.

10. A non-transitory computer-readable medium having embodied thereon a computer program for executing a method for allocating a price discovery mechanism in a data marketplace, the method comprising a processor implemented steps of:
accessing the data marketplace by a one or more buyers with a set of requirements for data products;
accessing the data marketplace by a one or more sellers with the data products for sale, wherein the data products have a set of specifications;
matching the set of requirements of the buyers with the set of specifications using a matching module (108), wherein the output of the matching module is used to decide whether to proceed with data transactions or not;
classifying the data marketplace based on a number of buyers and a number of sellers accessing the data marketplace using a classification module (110); and
allocating a price discovery mechanism to at least one of a bid order matching mechanism, an auctioning mechanism or a direct negotiation mechanism for the data marketplace based on the classification.
